(19) United States
(12) Patent Application Publication
(10) Pub. No.: US 2026/0186156 A1
(43) Pub. Date: Jul. 2, 2026

(54) SYSTEM AND METHOD FOR LIGHT SOURCE FOCAL POINT POSITION MEASUREMENT

(71) Applicant: INDUSTRIAL TECHNOLOGY RESEARCH INSTITUTE, Hsinchu (TW)

(72) Inventor: Fu-Cheng YANG, Xinpu Township (TW)

(73) Assignee: INDUSTRIAL TECHNOLOGY RESEARCH INSTITUTE, Hsinchu (TW)

(21) Appl. No.: 19/002,516

(22) Filed: Dec. 26, 2024

(51) Int. Cl. G01N 23/041; G01N 23/20

(52) U.S. Cl. CPC G01N 23/041; G01N 23/20

(57) ABSTRACT

A light source focal position measurement system is provided, including a light source, an image sensor, a first two-dimensional (2D) amplitude grating, and a second 2D amplitude grating. The light source is located on a light path. The first 2D amplitude grating is between the light source and the second 2D amplitude grating, and the second 2D amplitude grating is between the first 2D amplitude grating and the image sensor. The centers of the first and second 2D amplitude gratings are on the light path. The light source generates an image having a 2D periodic pattern through the first and second 2D amplitude gratings. The 2D periodic pattern has a period and first and second phase shifts. The image sensor generates coordinates of the focal position of the light source based on the period and the first and second phase shifts.

### TECHNICAL FIELD

The present invention relates to systems and methods for measuring the focal position of a point light source, and, in particular, to real-time measurement of the focal position offset of an X-ray source.

### BACKGROUND

X-ray image measurement systems generally irradiate an object with a light source to obtain projection data, and use the data to reconstruct the image to obtain a three-dimensional (3D) image of the object. However, after multiple iterations of irradiation, the focal position of the light source may be offset, thereby causing errors in the acquired image. In addition, if the focal position offset is calculated when the object is not being irradiated, or if the reference value of the focus offset is found by default, the measurement may become slow and the error cannot be detected in real time. Therefore, a solution to the above problems is needed.

### SUMMARY

According to an embodiment of the present invention, a light source focal position measurement system is provided, including a light source, an image sensor, a first two-dimensional (2D) amplitude grating, and a second 2D amplitude grating. The light source is located on a light path. The first 2D amplitude grating is located between the light source and the second 2D amplitude grating, and the second 2D amplitude grating is located between the first 2D amplitude grating and the image sensor.

The centers of the first 2D amplitude grating and the second 2D amplitude grating are on the light path. The light source generates an image through the first 2D amplitude grating and the second 2D amplitude grating, wherein the image has a 2D periodic pattern. The 2D periodic pattern has a period, a first phase shift, and a second phase shift. The first phase shift is located in a first direction that is perpendicular to the light path and is parallel to the surface, and the second phase shift is located in a second direction that is perpendicular to the light path and the first direction. The image sensor generates coordinates of the focal position of the light source based on the period, the first phase shift, and the second phase shift.

According to an embodiment of the present invention, the light source focal position measurement system further includes a reflector, located between the first 2D amplitude grating and the second 2D amplitude grating and configured to change the direction of the light path.

According to an embodiment of the present invention, the light source focal position measurement system further includes a processor, configured to calculate the current focal position offset based on the coordinates of the focal position to perform error corrections on the image.

According to an embodiment of the present invention, a method for measuring light source focal position is provided, including: obtaining an image of a light source through a first two-dimensional (2D) amplitude grating and a second 2D amplitude grating, wherein the image has a 2D periodic pattern; and calculating current coordinates of a focal position based on a period, a first phase shift, and a second phase shift of the 2D periodic pattern.

The first 2D amplitude grating and the second 2D amplitude grating are parallel to each other and are on the same line. The first phase shift is located in a first direction that is perpendicular to the line and is parallel to the first 2D amplitude grating and the second 2D amplitude grating. The second phase shift is located in a second direction that is perpendicular to the line and the first direction.

According to an embodiment of the present invention, the method further includes calculating the current focal position offset based on the coordinates of the focal position to perform error corrections on the image.

According to an embodiment of the present invention, the second 2D amplitude grating is in contact with the surface of the image sensor. According to another embodiment of the present invention, the first 2D amplitude grating and the second 2D amplitude grating are sine wave gratings, square wave gratings, or triangle wave gratings with analyzable frequency differences.

### BRIEF DESCRIPTION OF THE DRAWINGS

FIG. 1A is a schematic diagram of a light source focal position measurement system according to an embodiment of the present invention.

FIG. 1B is an equivalent block diagram of a light source focal position measurement system according to an embodiment of the present invention.

FIG. 1C is a schematic diagram of a light source focal position measurement system according to another embodiment of the present invention.

FIG. 2 is a schematic diagram of a coordinate system of a light source focal position measurement system according to an embodiment of the present invention.

FIG. 3 is a flow chart of a method for measuring the focal position of a light source according to an embodiment of the present invention.

### DETAILED DESCRIPTION

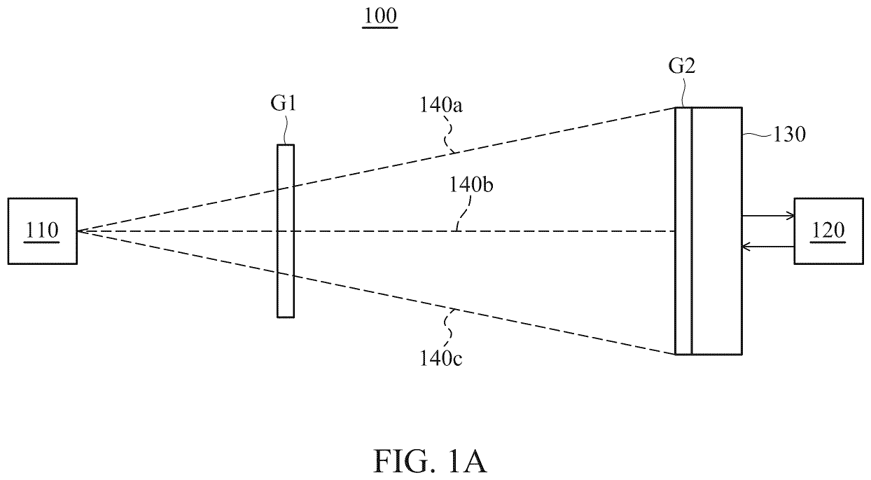

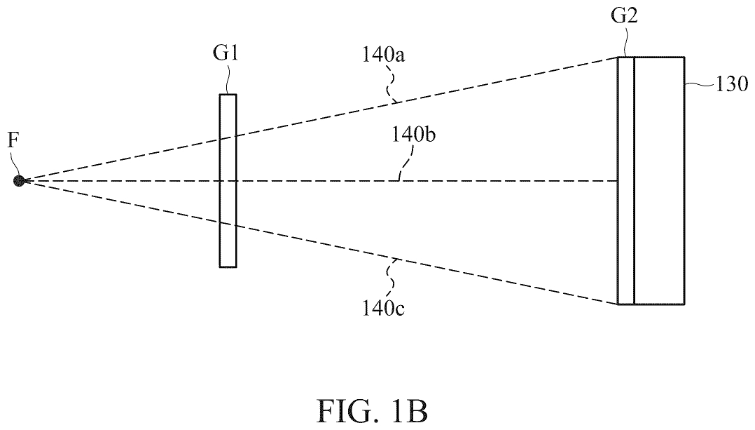

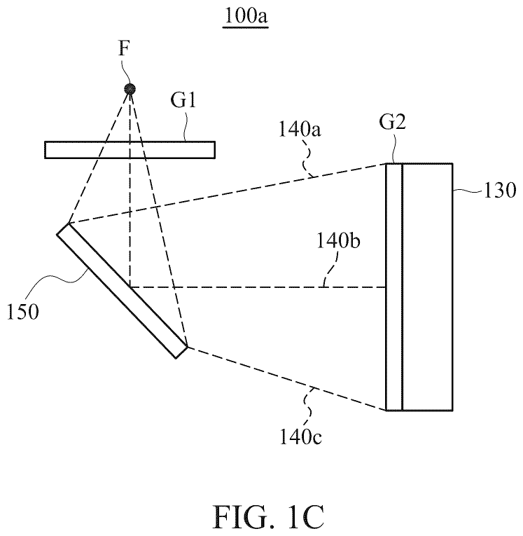

FIG. 1A is a schematic diagram of a light source focal position measurement system 100 according to an embodiment of the present invention. The light source focal position measurement system 100 includes a light source 110, two-dimensional (2D) amplitude gratings G1 and G2, and an image detector 130. The light source 110 emits light (e.g., X-rays along the light paths 140a, 140b, and 140c shown in FIG. 1), which sequentially penetrates the 2D amplitude gratings G1 and G2, and finally forms an image on the image detector 130. The 2D amplitude grating G1 is located between the light source 110 and the 2D amplitude grating G2. The 2D amplitude grating G2 is located between the 2D amplitude grating G1 and the image detector 130. The 2D amplitude gratings G1 and G2 are parallel to each other. In one embodiment, the 2D amplitude grating G2 is in contact with a surface of the image detector 130. In addition, in one embodiment, the light path 140b is perpendicular to the surface of the image detector 130, and the light path 140b passes through the centers of the 2D amplitude gratings G1 and G2.

FIG. 1B is an equivalent block diagram of the light source focal position measurement system 100 according to an embodiment of the present invention, in which the light source 110 is replaced by a focal point F. FIG. 1B shows the light source focal position measurement system 100 in a state where no focal position offset occurs, i.e., the focal point F is located at the height (e.g., z-axis coordinate) of the preset focal position of the light source 110 and is located on the light path 140b together with the centers of the 2D amplitude gratings G1 and G2, wherein the light path 140b is perpendicular to the surface of the image detector 130. When the focal point F is shifted, it may shift on the x-axis, y-axis, or z-axis. For example, the x-axis coordinate, y-axis coordinate, or z-axis coordinate of the focal point F may be different from the coordinates of the preset focal position.

FIG. 1C is a schematic diagram of the light source focal position measurement system 100a according to another embodiment of the present invention. Similar to the light source focal position measurement system 100, the light source focal position measurement system 100a includes the light source 110 (represented by the focal point F in FIG. 1C), 2D amplitude gratings G1 and G2, and the image detector 130. The 2D amplitude grating G2 are not parallel to each other. For the image detector 130 to detect the light source 110, the light source focal position measurement system 100a further includes a reflector 150, which is configured to change the directions of the light emitted by the light source 110 (e.g., the light traveling along the light paths 140a, 140b, and 140c). For example, referring to FIG. 1C, light paths 140a, 140b, and 140c extend from the focal point F of the light source 110. After encountering the reflector 150, the light is reflected to the image detector 130 based on the inclination angle of the reflector 150, wherein the image detector 130 is not located on the same line as the light source 110 (or focal point F). Thus, if the light source 110 cannot directly project light to the image detector 130 during the process of measuring the light source focal position, the light can be redirected by the reflector 150 so that the light paths 140a, 140b, and 140c can extend continuously from the light source 110 (or the focal point F) to the image detector 130.

It should be noted that the reflector 150 is used to change the direction of the light from the light source 110. Therefore, in addition to being placed between the 2D amplitude gratings G1 and G2 as shown in FIG. 1C, the reflector 150 can also be placed between the light source 110 and the 2D amplitude grating G1, or between the 2D amplitude grating G2 and the image detector 130.

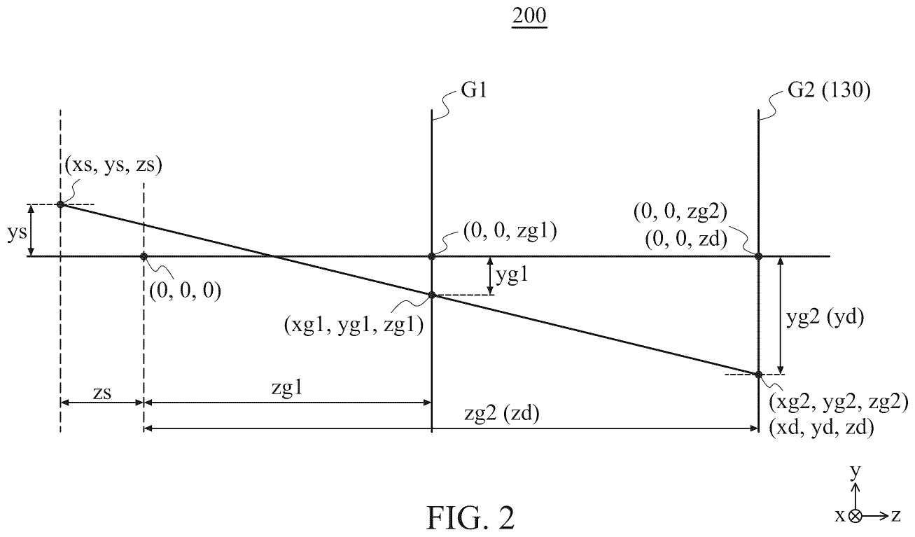

FIG. 2 is a schematic diagram of a coordinate system 200 of the light source focal position measurement system 100 according to an embodiment of the present invention. Referring to FIG. 2, assuming that the horizontal direction is the z-axis and the vertical direction is the y-axis, the x-axis direction is the incident paper surface. Therefore, the coordinate system 200 only shows the coordinate positions in the y-axis direction and the z-axis direction. Assume that the preset coordinates of the focal point F of the light source 110 are the origin (i.e., (0,0,0) in FIG. 2), and when passing through the 2D amplitude gratings G1 and G2, one of the light paths intersects with the 2D amplitude gratings G1 and G2 at the coordinate positions (0,0,zg1) and (0,0,zg2), respectively, and intersects with the image detector 130 at the coordinate position (0,0,zd). It should be noted that since the 2D amplitude grating G2 is in contact with the surface of the image detector 130, the z-axis distances zg2 and zd are considered equal.

After the offset occurs, the coordinates of the focal point F move from (0,0,0) to (xs, ys, zs). At the same time, the intersection of any light path of the light source and the 2D amplitude grating G1 is (xg1, yg1, zg1), and the intersection of any light path of the light source and the 2D amplitude grating G2 is (xg2, yg2, zg2). In addition, the intersection of the light path and the image detector 130 is (xd, yd, zd) after the focal point F is shifted. The following is a detailed description of the measurement and calculation of the light source focal position. According to the coordinates before and after the shift as described above, the energy received by the image detector 130 can be expressed as follows:

$$Energy I ( xd , yd ) = S \times T ( xg 1 , yg 1 ) \times T ( xg 2 , yg 2 ) = S \times [ 0 \text{.5} + 0.5 cos ( {f}_{g 1} \times xg 1 + {f}_{g 1} \times yg 1 ) ] \times [ 0.5 + 0.5 cos ( {f}_{g 2} \times xg 2 + {f}_{g 2} \times yg 2 ) ] \qquad equation ( 1 )$$

Wherein S is the light energy, T (xg1, yg1) and T (xg2, yg2) are the transmittance distributions of the 2D amplitude gratings G1 and G2, respectively, and fg1 and fg2 are the spatial frequencies of the 2D amplitude gratings G1 and G2, respectively.

In addition, under the condition of focal position offset, the x-axis position xg1 and the y-axis position yg1 of the intersection of the light path and the 2D amplitude grating G1 can be expressed as:

$$xg 1 = \frac{z g 1 - z s}{z d - z s} \times ( x d - x s ) + x s = \frac{1}{Mg 1} \times ( x d - x s ) + xs \qquad equation ( 2 a )$$

$$yg 1 = \frac{z g 1 - z s}{z d - z s} \times ( y d - y s ) + y s = \frac{1}{Mg 1} \times ( y d - y s ) + ys \qquad equation ( 2 b )$$

Wherein Mg1 is the ratio of the difference between the z-axis position zd of the intersection of the light path and the image detector 130 and the z-axis position zs of the offset focal point F (i.e., zd-zs), and the difference between the z-axis position zd of the intersection of the light path and the 2D amplitude grating G1 and the z-axis position zs of the offset focal point F (i.e., zg1-zs). Since the 2D amplitude gratings G1 and G2 and the image detector 130 are parallel to each other, the x-axis position xg1 can be calculated through Mg1, the x-axis positions xd and xs, and the z-axis positions zd, zs, and zg1. The same method can also be used to calculate the y-axis position yg1. The x-axis positions xd, xs and the z-axis positions zd, zs, and zg1 can be obtained by detecting the 2D periodic pattern of the 2D amplitude grating G1, G2 by the image detector 130.

After expanding equation (1), only the terms that are not DC terms and high-frequency terms are retained, and equation (1) is rewritten as follows:

$$S \times cos ( {f}_{g 1} \times xg 1 + {f}_{g 1} \times yg 1 ) \times cos ( {f}_{g 2} \times xg 2 + {f}_{g 2} \times yg 2 ) = S \times 0.5 \times [ cos ( {f}_{g 1} \times xg 1 + {f}_{g 1} \times yg 1 + {f}_{g 2} \times xg 2 + {f}_{g 2} \times yg 2 ) + cos ( {f}_{g 1} \times xg 1 + {f}_{g 1} \times yg 1 - {f}_{g 2} \times xg 2 - {f}_{g 2} \times yg 2 ) ] \qquad equation ( 3 )$$

Next, substitute equations (2a) and (2b) into equation (3) and remove the high-frequency terms to rewrite it as follows:

$$S \times 0.5 cos ( {f}_{g 1} \times xg 1 + {f}_{g 1} \times yg 1 - {f}_{g 2} \times xg 2 - {f}_{g 2} \times yg 2 ) = S \times 0.5 cos [ ( \frac{{f}_{g 1}}{Mg 1} - {f}_{g 2} ) \times x d + ( 1 - \frac{{f}_{g 1}}{Mg 1} ) \times xs + ( \frac{{f}_{g 1}}{Mg 1} - {f}_{g 2} ) \times yd + ( 1 - \frac{{f}_{g 1}}{Mg 1} ) \times y s ] \qquad equation ( 4 a )$$

Referring to equation (4a), f_{g1} and f_{g2} in the terms

$$( \frac{{f}_{g 1}}{M g 1} - {f}_{g 2} ) \times xd and ( \frac{{f}_{g 1}}{M g 1} - {f}_{g 2} ) \times y d$$

are the spatial frequencies of the 2D amplitude gratings G1 and G2, and xd and yd are the x-axis position and y-axis position of the intersection of the light path and the image detector 130. Then, the overall phase of equation (4a) at the z-axis position zs and 0 (i.e., the origin) is partially differentiated with respect to xd and yd, and the following equation is obtained:

$$Partially differentiated at the z - axis position zs : {f}_{x} ( zs ) = ( \frac{{f}_{g 1}}{Mg 1} - {f}_{g 2} ) \qquad equation ( 5 a )$$

$$Partially differentiated at the z - axis position zs : {f}_{x} ( 0 ) = {f}_{y} ( 0 ) = ( \frac{{f}_{g 1}}{Mg 10} - {f}_{g 2} ) \qquad equation ( 5 b )$$

Wherein

$$Mg 10 = \frac{zg 1}{z d}$$

is the Mg1 when the z-axis position is 0 (i.e., at the origin). Therefore, it can be inferred that the frequency difference between the 2D amplitude gratings G1 and G2 when the focal point F of the light source 110 is not offset and when it is offset is:

$$Δ {f}_{x} = Δ {f}_{y} = ( \frac{zg 1 - zs}{zd - zs} - \frac{zg 1}{z d} ) \times {f}_{g 1} \qquad equation ( 6 )$$

Therefore, by appropriately setting the relative positions of the 2D amplitude gratings G1 and G2 and the image detector 130 (i.e., setting appropriate z-axis positions zd and zg1, x-axis position xd, and y-axis position yd), and selecting the corresponding spatial frequencies (e.g., f_{g1} and f_{g2}), the light source focal position measurement system 100 can match the 2D periodic pattern of the 2D amplitude gratings G1 and G2 to the resolution of the image detector 130, and thus use a lower frequency to achieve a higher frequency resolution to increase the sensitivity of measuring z-axis position offset.

Furthermore, referring to equation (6), the frequency difference when the focal point F is located at the origin (i.e., the z-axis position is 0) and when there is an offset (i.e., the z-axis position is zs) is affected by the relative positions of the 2D amplitude grating G1, G2 and the image detection (i.e., the z-axis positions zd and zg1) and the spatial frequency of the 2D amplitude grating G1 (i.e., f_{g1}). Therefore, after the relative positions of the 2D amplitude gratings G1, G2 and the image detector 130 and the spatial frequency of the 2D amplitude grating G1 are determined, the image detector 130 detects the 2D periodic pattern formed by the light source 110 penetrating the 2D amplitude gratings G1 and G2, and the current z-axis position offset of the focal point F can be inferred through the frequency difference.

Still referring to equation (4a), when the cosine value is zero, it means that the phase is zero, i.e., the focal point F has no offset. Therefore, if the offset occurs, the following relationship can be derived from equation (4a):

$$xd = \frac{1 - \frac{{f}_{g 1}}{Mg 1}}{\frac{{f}_{g 1}}{Mg 1} - {f}_{g 2}} \times xs \qquad equation ( 7 a )$$

$$yd = \frac{1 - \frac{{f}_{g 1}}{Mg 1}}{\frac{{f}_{g 1}}{Mg 1} - {f}_{g 2}} \times ys \qquad equation ( 7 b )$$

According to equations (7a) and (7b), the x-axis position xs and y-axis position ys of the focal point F after the shift can be inferred based on the relative position of the light source 110, the 2D amplitude gratings G1, G2 and the image detector (i.e., Mg1), the z-axis position zs obtained by equation (6), and the spatial frequencies of the 2D amplitude gratings G1 and G2 (i.e., f_{g1} and f_{g2}).

Additionally, still referring to equations (7a) and (7b). Regarding the terms

$$\frac{1 - \frac{{f}_{g 1}}{Mg 1}}{\frac{{f}_{g 1}}{Mg 1} - {f}_{g 2}} \times xs and \frac{1 - \frac{{f}_{g 1}}{Mg 1}}{\frac{{f}_{g 1}}{Mg 1} - {f}_{g 2}} \times y s ,$$

it can be inferred that to improve the measurement resolution of the offset in the x-axis and y-axis directions, the spatial frequencies of the 2D amplitude gratings G1 and G2 (i.e., f_{g1} and f_{g2}) and Mg1 affect the measurements of the x-axis position xs and the y-axis position ys. Therefore, when operating the light source focal position measurement system 100, the spatial frequency of the 2D amplitude grating G1 is adjusted first. Then, the relative positions of the 2D amplitude gratings G1 and G2 and the image detector 130 are adjusted. The matched spatial frequency of the 2D amplitude grating G2 is also selected. These determine the measurement resolution in the x-axis and y-axis directions so that the focal position measurement of different frequencies and resolutions of the light source 110 or the image detector 130 can be achieved.

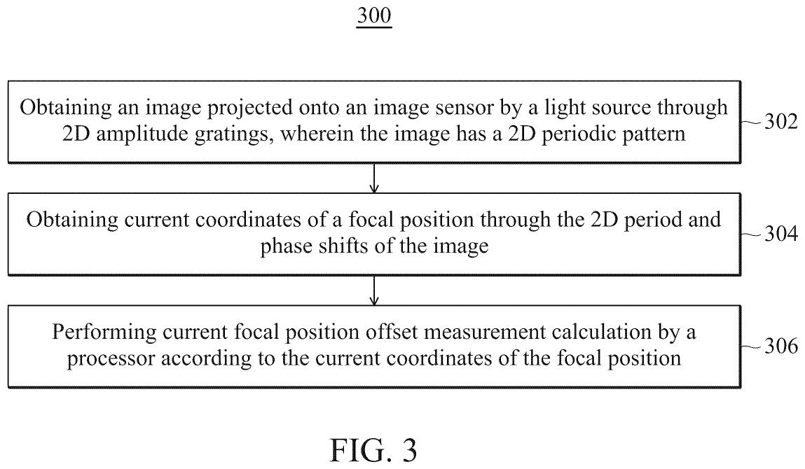

FIG. 3 is a flow chart of a method 300 for measuring the focal position of a light source according to an embodiment of the present invention. The image detector 130 receives multiple images at different angles when the object to be measured is projected to construct a 3D model. Therefore, the process of method 300 is performed to measure the instantaneous focal position each time after the light source focal position measurement system 100 of the present invention generates an image by irradiation. In step 302, the light source 110 emits light and sequentially passes through the 2D amplitude gratings G1 and G2, and forms an image having a 2D periodic pattern on the surface of the image detector 130. Next, in step 304, the image detector 130 detects the period and phase shift of the 2D periodic pattern to obtain the z-axis position of the focal point F corresponding to the period and the x-axis and y-axis positions of the focal point F corresponding to the phase shift. Specifically, the phase shift is caused by the offset of the x-axis position or y-axis position of the focal point F of the light source 110, and the period change is caused by the offset of the z-axis position of the focal point F.

In one embodiment, the method 300 further includes step 306, where the processor 120 of the light source focal position measurement system 100 calculates the current focal position offset according to the current focal position detected by the image detector 130. Next, according to the calculated focal position offset, performs error corrections on the current image detected by the image detector 130 to prevent the image fed back to the 3D model reconstruction modules from being affected by the offset of the focal point F, thereby preventing the model reconstruction from distorting or failing due to focal position offset.

For example, the data for calculating the current focal position offset of the light source focal position measurement system 100 is shown in Table 1 below (it is assumed that there is no offset in the v-axis direction herein):

TABLE 1

| Parameter | Value | Parameter | Value |
|---|---|---|---|
| zg1 (mm) | 40 | xd (mm) | 0.2363 |
| zd (mm) | 250 | Mg1 | 6.251 |
| fg₁ (lp/mm) | 600 | Mg10 | 6.25 |
| fg₂ (lp/mm) | 100 | Δf (lp/mm) | −0.02016 |

According to equation

$$( 6 ) \cdot Δ {f}_{x} = Δ {f}_{y} = Δ f = ( \frac{zg 1 - z s}{z d - z s} - \frac{zg 1}{z d} ) \times {f}_{g 1} ,$$

substituting the measured z-axis positions zd and zg1, the spatial frequency of the 2D amplitude grating G1 (i.e., f_{g1}), and the frequency difference (i.e., Δf), it can be inferred that the z-axis position zs=0.01 (mm). Then, based on equations (2a) and (2b), it can be inferred that

$$Mg 1 = \frac{z d - z s}{z g 1 - z s} = 6.251 , and$$

$$Mg 10 = \frac{z d}{z g 1} = 6.25 .$$

Next, based on equation (7a)

$$( i . e . , xd = \frac{1 - \frac{{f}_{g 1}}{Mg 1}}{\frac{{f}_{g 1}}{Mg 1} - {f}_{g 2}} \times xs ) ,$$

substituting the measured x-axis position xd, the spatial frequencies of the 2D amplitude gratings G1 and G2 (f_{g1} and f_{g2}), and the Mg1 derived as above, the x-axis position xs=0.01 (mm) can be inferred. Therefore, through the above calculation, the current focal position coordinates of the light source focal position measurement system 100 can be obtained as (0.01, 0, 0.01). In addition, if the y-axis position ys is to be calculated, the value of the y-axis position ys can be inferred according to equation (7b) and referring to the aforementioned calculation process of the x-axis position xs.

It should be noted that according to equation (6), the method used by the present invention to measure the offset of the z-axis position is to utilize the difference in spatial frequencies (i.e., frequency difference) of the 2D amplitude gratings G1 and G2 for measurement. Therefore, the 2D amplitude gratings G1 and G2 are gratings with analyzable frequency differences such as sine wave gratings, square wave gratings, triangle wave gratings, etc. In addition, the method 300 for measuring the focal position of a light source only requires one image (i.e., the light source 110 only needs to perform one projection) to measure the current position of the focal point F of the light source 110, making the measurement process faster and simpler. Further, error correction can be performed on each image in real time.

The invention provides a light source focal position measurement system, which includes a light source, two 2D amplitude gratings, and an image detector. The light source emits light, which sequentially penetrates two 2D amplitude gratings and forms an image with a 2D periodic pattern on the image detector. The image detector detects the period and phase shift of the 2D periodic pattern to obtain the current coordinates of the focal position. In one embodiment, the light source focal position measurement system further includes a processor configured to calculate a position offset according to current coordinates of the focal position to perform error correction on the current image. In one embodiment, the light source focal position measurement system further includes a reflector for changing the light path of the light emitted by the light source so that the image detector does not need to be located on the same line as the light source to perform focal position measurement.

The present invention also provides a method for measuring the focal position of a light source, comprising forming an image having a 2D periodic pattern on an image detector through a 2D amplitude grating, and shifting or taking a phase according to the period and phase of the 2D periodic pattern. In one embodiment, the method further includes calculating an offset according to a current light source focal position, and performing error corrections on the current image using the calculated offset.

What is claimed is:

1. A light source focal position measurement system, comprising:
a light source and an image sensor; and
a first two-dimensional (2D) amplitude grating and a second 2D amplitude grating, wherein the first 2D amplitude is located between the light source and the second 2D amplitude grating, and the second 2D amplitude grating is located between the first 2D amplitude grating and the image sensor,
wherein centers of the first 2D amplitude grating and the second 2D amplitude grating are on a light path;
wherein the light source generates an image through the first 2D amplitude grating and the second 2D amplitude grating, the image has a 2D periodic pattern, and the 2D periodic pattern has a period, a first phase shift, and a second phase shift, the first phase shift is located in a first direction which is perpendicular to the light path and is parallel to the surface, and the second phase shift is located in a second direction which is perpendicular to the light path and the first direction;
wherein the image sensor generates coordinates of a focal position of the light source through the period, the first phase shift, and the second phase shift.

2. The light source focal position measurement system as claimed in claim 1, wherein the second 2D amplitude grating is in contact with the surface of the image sensor.

3. The light source focal position measurement system as claimed in claim 1, further comprising a reflector, located between the first 2D amplitude grating and the second 2D amplitude grating, wherein the reflector is configured to change a direction of the light path.

4. The light source focal position measurement system as claimed in claim 1, further comprising a processor, configured to calculate a current focal position offset based on the coordinates of the focal position to perform error corrections on the image.

5. The light source focal position measurement system as claimed in claim 1, wherein the first 2D amplitude grating and the second 2D amplitude grating are parallel to the surface of the image sensor.

6. The light source focal position measurement system as claimed in claim 1, wherein the first 2D amplitude grating and the second 2D amplitude grating are sine wave gratings, square wave gratings, or triangle wave gratings with analyzable frequency difference.

7. The light source focal position measurement system as claimed in claim 1, wherein the light source is an X-ray source.

8. A method for measuring light source focal position, comprising:
obtaining an image of a light source through a first two-dimensional (2D) amplitude grating and a second 2D amplitude grating, wherein the image has a 2D periodical pattern; and
calculating current coordinates of a focal position based on a period, a first phase shift, and a second phase shift of the 2D periodic pattern,
wherein the first 2D amplitude grating and the second 2D amplitude grating are parallel to each other and are on the same line; and
wherein the first phase shift is located in a first direction that is perpendicular to the line and is parallel to the first 2D amplitude grating and the second 2D amplitude grating, and the second phase shift is in a second direction that is perpendicular to the line and the first direction.

9. The method for measuring light source focal position as claimed in claim 8, further comprising:
calculating a current focal position offset based on the coordinates of the focal position to perform error corrections on the image.

10. The method for measuring light source focal position as claimed in claim 8, wherein the first 2D amplitude grating and the second 2D amplitude grating are sine wave gratings, square wave gratings, or triangle wave gratings with analyzable frequency difference.
